(19) United States
(12) Patent Application Publication
(10) Pub. No.: US 2026/0302388 A1
(43) Pub. Date: Oct. 1, 2026

(54) ENERGY STORAGE DEVICE

(71) Applicant: TOYOTA JIDOSHA KABUSHIKI KAISHA, Toyota-shi (JP)

(72) Inventors: Naoya KAWAMOTO, Nisshin-shi (JP); Yuya INOUE, Nagoya-shi (JP)

(73) Assignee: TOYOTA JIDOSHA KABUSHIKI KAISHA, Toyota-shi (JP)

(21) Appl. No.: 19/453,120

(22) Filed: Jan. 20, 2026

(30) Foreign Application Priority Data
Mar. 26, 2025 (JP) 2025-052183

(51) Int. Cl. H01M 10/42; H01M 50/209; H01M 50/507

(52) U.S. Cl. CPC H01M 10/425; H01M 50/209; H01M 50/507; H01M 2220/20

(57) ABSTRACT

The energy storage device includes: a plurality of energy storage modules; a positive busbar that is connected to a positive electrode of the energy storage module located at a first end, and extends on one side of the energy storage modules; a negative busbar that is connected to a negative electrode of the energy storage module located at a second end, and extends on the one side of the energy storage modules; a pair of neutral-point busbars that is respectively connected to positive and negative electrodes of the energy storage module located at an intermediate position, and extends on the one side of the energy storage modules; and a noise filter attached so as to surround at least part of a portion, extending on the one side of the energy storage modules, of at least one of the positive busbar, the negative busbar, and the neutral-point busbars.

### CROSS-REFERENCE TO RELATED APPLICATION

This application claims priority to Japanese Patent Application No. 2025-052183 filed on Mar. 26, 2025. The disclosure of the above-identified application, including the specification, drawings, and claims, is incorporated by reference herein in its entirety.

### BACKGROUND

### 1. Technical Field

The technology of the present disclosure relates to energy storage devices.

### 2. Description of Related Art

Japanese Unexamined Patent Application Publication No. 2023-046719 (JP 2023-046719 A) describes a structure in which a battery pack including a housing case and busbars and a battery stack housed inside the housing case is mounted on a vehicle.

### SUMMARY

In a structure in which a battery stack is connected by busbars, such as the structure disclosed in JP 2023-046719 A, external noise may enter the busbars. Such noise may adversely affect operations such as charge and discharge control of the battery pack.

In view of the above issue, an object of the present disclosure is to provide an electricity storage device that can remove noise entering busbars with a simple configuration.

In order to achieve the above object, an energy storage device according to claim1 includes: a plurality of energy storage modules each including a plurality of energy storage cells arranged along a first direction, the energy storage modules being arranged along a second direction intersecting the first direction and electrically connected to each other; a positive busbar that is connected to a positive electrode of the energy storage module located at a first end in the second direction among the energy storage modules, and extends on one side of the energy storage modules in the first direction; a negative busbar that is connected to a negative electrode of the energy storage module located at a second end in the second direction among the energy storage modules, and extends on the one side of the energy storage modules; a pair of neutral-point busbars that is respectively connected to a positive electrode and a negative electrode of the energy storage module located at an intermediate position in the second direction among the energy storage modules, and extends on the one side of the energy storage modules; and a noise filter attached so as to surround at least part of a portion, extending on the one side of the energy storage modules, of at least one of the positive busbar, the negative busbar, and the neutral-point busbars.

In the electricity storage device of claim 1, noise entering each busbar can be removed with a simple configuration. This configuration does not affect the installation space for the energy storage modules.

According to an energy storage device of claim 2, in the energy storage device of claim 1, the noise filter includes a first noise filter attached so as to surround a part of the positive busbar and a part of one of the neutral-point busbars, and a second noise filter attached so as to surround a part of the negative busbar and a part of the other neutral-point busbar.

In the energy storage device of claim 2, since a single noise filter can be attached to multiple busbars, the total number of noise filters can be reduced compared with a case where one noise filter is attached to each busbar.

According to an energy storage device of claim 3, in the energy storage device of claim 2, a direction of current flowing through the part of the positive busbar and the part of the one neutral-point busbar to which the first noise filter is attached, and a direction of current flowing through the part of the negative busbar and the part of the other neutral-point busbar to which the second noise filter is attached, are opposite to each other.

In the energy storage device of claim 3, since the directions of the currents flowing through the two busbars to which a single noise filter are opposite to each other, common-mode noise can be effectively removed.

According to an energy storage device of claim 4, in the energy storage device of any one of claims 1 to 3, the energy storage device further includes an electrical device connected to the energy storage modules and positioned so as to at least partially overlap the positive busbar, the negative busbar, and the neutral-point busbars in a third direction intersecting both the first direction and the second direction, and the positive busbar, the negative busbar, and the neutral-point busbars are electrically connected to the electrical device.

In the energy storage device of claim 4, since the electrical device can be disposed near the busbars, the overall length of each busbar can be reduced. In addition, since the electrical device is arranged at a height different from that at which the energy storage modules and the busbars are arranged, the installation space for the energy storage modules is not restricted by the installation of the electrical device.

According to an energy storage device of claim 5, in the energy storage device of any one of claims 1 to 4, the energy storage device further includes a housing in which the energy storage modules arranged in parallel along the second direction are installed, and the housing includes a module installation region in which the energy storage modules are installed, and a busbar placement region that is provided on the one side of the module installation region and in which the positive busbar, the negative busbar, and the neutral-point busbars are disposed.

In the energy storage device of claim 5, the housing can protect not only the energy storage modules but also the busbars from external impacts etc.

The above energy storage device can remove noise entering the busbars with a simple configuration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view illustrating an example of an energy storage device1 according to one embodiment;

FIG. 2 is an enlarged exploded perspective view illustrating a main part of the energy storage device shown in FIG. 1;

FIG. 3 is a schematic enlarged plan view illustrating a busbar placement region of the energy storage device shown in FIG. 1;

FIG. 4 is an enlarged perspective view illustrating a main part of a positive busbar and one of a pair of neutral-point busbars; and

FIG. 5 is an enlarged perspective view illustrating a main part of a negative busbar and the other neutral-point busbar.

### DETAILED DESCRIPTION OF EMBODIMENTS

Embodiments for carrying out the present disclosure will be described below with reference to the drawings. The following description schematically illustrates aspects relevant to achieving the object of the present disclosure, and focuses on the corresponding portions of the disclosure. Portions not described in detail are assumed to be based on known techniques. Identical or equivalent components are denoted by the same or similar signs throughout the drawings, and repetitive description will be omitted. When multiple identical or equivalent components are included in the drawings, only some of them may be denoted by signs for clarity.

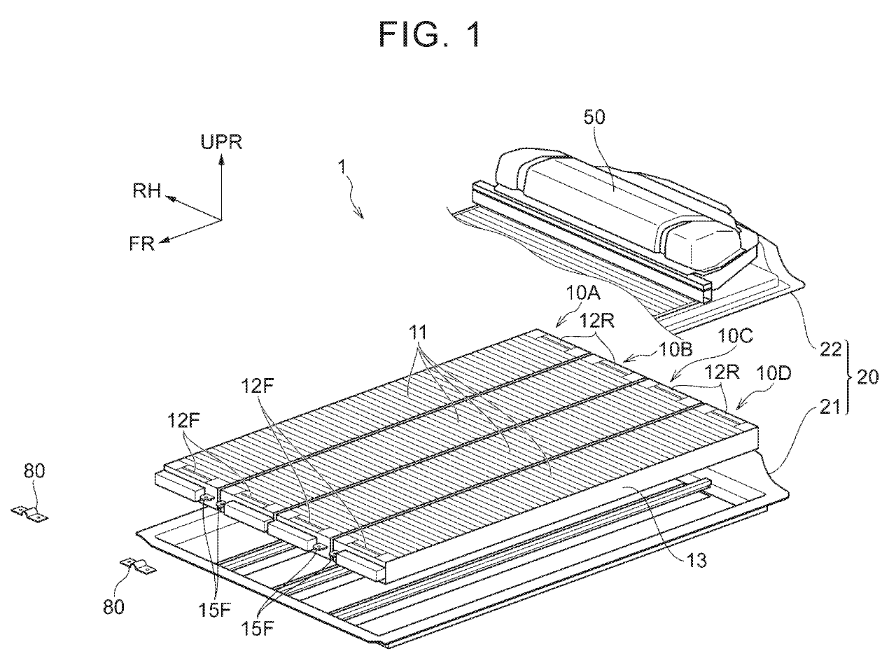

FIG. 1 is a schematic perspective view illustrating an example of an energy storage device 1 according to one embodiment. An energy storage device 1 of the present embodiment is described as an example that is mounted at a suitable location in a vehicle, for example on the floor portion. In FIG. 1, arrow FR corresponds to the forward direction of the vehicle on which the energy storage device 1 is mounted, arrow UPR corresponds to the upward direction of the vehicle, and arrow RH corresponds to the rightward direction of the vehicle. In the following description, the direction along arrow FR is referred to as the "front-rear direction," the direction along arrow RH as the "left-right direction," and the direction along arrow UPR as the "up-down direction." The front-rear direction is an example of the "first direction," the left-right direction is an example of the "second direction," and the up-down direction is an example of the "third direction."

As shown in FIG. 1, the energy storage device 1 of the present embodiment includes: a plurality of energy storage modules 10A to 10D; and a positive busbar 30, a negative busbar 40, and a pair of neutral-point busbars 60, 70 electrically connected to the energy storage modules 10A to 10D. The energy storage device 1 of the present embodiment may further include a housing 20 in which the energy storage modules 10A to 10D are installed.

Each of the energy storage modules 10A to 10D includes a plurality of energy storage cells 11 arranged along the front-rear direction. As shown in FIG. 1, the energy storage device 1 of the present embodiment exemplifies a configuration in which four energy storage modules 10A to 10D elongated in the front-rear direction are arranged substantially in parallel within the housing 20. For ease of description, the four energy storage modules 10A to 10D are sometimes referred to as the "first energy storage module 10A," the "second energy storage module 10B," the "third energy storage module 10C," and the "fourth energy storage module 10D," respectively. In the present embodiment, the four energy storage modules 10A to 10D are connected in series with each other.

Although the four energy storage modules 10A to 10D have slight differences in the layout of terminals 15F, 15R and other details, they may have substantially the same configuration. Specifically, each of the four energy storage modules 10A to 10D may include a plurality of energy storage cells 11 aligned in a single row along the front-rear direction, end plates 12F, 12R respectively disposed at both ends of the row of the energy storage cells 11 in the front-rear direction and supporting the energy storage cells 11, and a support member 13 supporting the energy storage cells 11 and the end plates 12F, 12R.

The energy storage cells 11 may be, for example, prismatic cells elongated in the left-right direction. The energy storage cells 11 may be, but are not particularly limited to, lithium-ion cells, lithium iron phosphate (LFP) cells, or all-solid-state cells. Each energy storage cell 11 may be electrically connected to an adjacent energy storage cell 11.

The end plates 12F, 12R are plate-shaped members respectively disposed at the front and rear ends of the row of the energy storage cells 11, one at each end. Each of the energy storage modules 10A to 10D may be provided with one terminal 15F and one terminal 15R that form the positive and negative electrodes on the corresponding end plates 12F, 12R. The support member 13 is preferably shaped such that the energy storage cells 11 can be placed thereon.

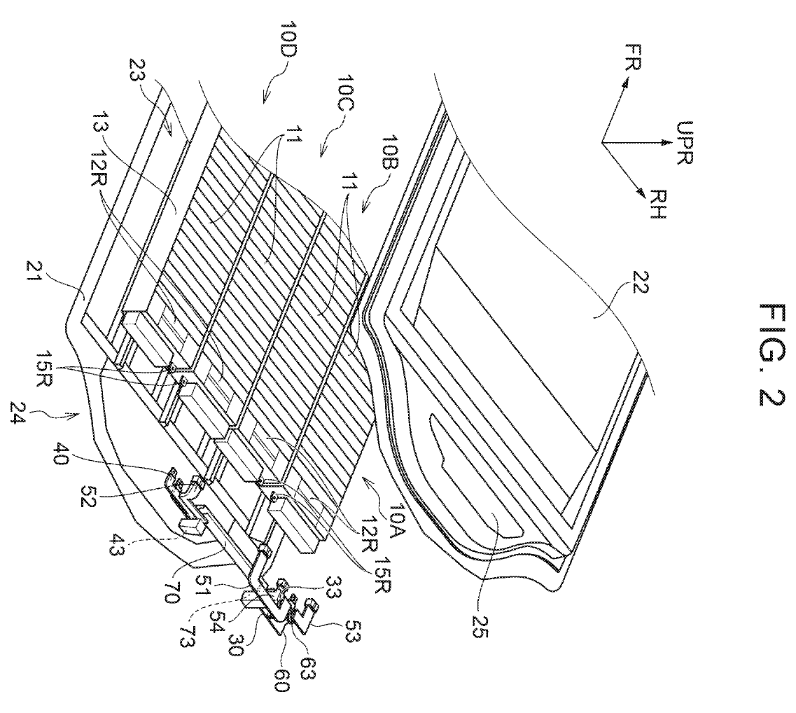

FIG. 2 is an enlarged exploded perspective view illustrating a main part of the energy storage device 1 shown in FIG. 1. The four energy storage modules 10A to 10D are arranged in parallel along the left-right direction inside the housing 20. The housing 20 protects the energy storage modules 10A to 10D and, as shown in FIGS. 1 and 2, may include a lower housing 21 and an upper housing 22. The lower housing 21 and the upper housing 22 may be made of a material having high impact resistance, such as a metal material. The number of energy storage modules installed in the housing 20 is not limited to four. However, since defining a neutral point (described later) is easier when the number is even, an even number of energy storage modules is preferable.

The lower housing 21 may be divided into a module installation region 23 on which the four energy storage modules 10A to 10D are placed, and a busbar placement region 24 in which the positive busbar 30, the negative busbar 40, and the neutral-point busbars 60, 70 are disposed.

The polarities of the terminals 15F, 15R of the four energy storage modules 10A to 10D installed in the module installation region 23 can be adjusted in accordance with the connection configuration among the energy storage modules 10A to 10D. In the present embodiment, the terminal 15F of the first energy storage module 10A forms the negative electrode, and the terminal 15R thereof forms the positive electrode. The terminal 15F of the second energy storage module 10B forms the positive electrode, and the terminal 15R thereof forms the negative electrode. The terminal 15F of the third energy storage module 10C forms the negative electrode, and the terminal 15R thereof forms the positive electrode. The terminal 15F of the fourth energy storage module 10D forms the positive electrode, and the terminal 15R thereof forms the negative electrode.

The upper housing 22 may have substantially the same shape as the lower housing 21. An electrical device 50 (see FIG. 1) may be installed on the upper rear portion of the upper housing 22. An opening 25 through which wires for electrically connecting the electrical device 50 and the energy storage modules 10A to 10D are routed may be provided in a portion of the upper housing 22 corresponding to the busbar placement region 24. In FIG. 1, the front portion of the upper housing 22 is omitted to make it easier to see the structures of the four energy storage modules 10A to 10D. The electrical device 50 is not shown in FIG. 2.

The electrical device 50 may include one or more devices selected, for example, from a junction box that controls charging and discharging of the energy storage modules 10A to 10D, a battery electronic control unit (ECU) that manages the operation of the junction box, and an onboard charger (OBC) used during charging. As shown in FIG. 1, the electrical device 50 is preferably positioned so as to at least partially overlap the positive busbar 30, the negative busbar 40, and the neutral-point busbars 60, 70 in the up-down direction, since this arrangement makes it possible to reduce the overall length of each busbar. This arrangement also helps reduce the overall length of the energy storage device 1 in the front-rear direction, compared with a case where the electrical device 50 is installed alongside the energy storage modules 10A to 10D in the horizontal direction.

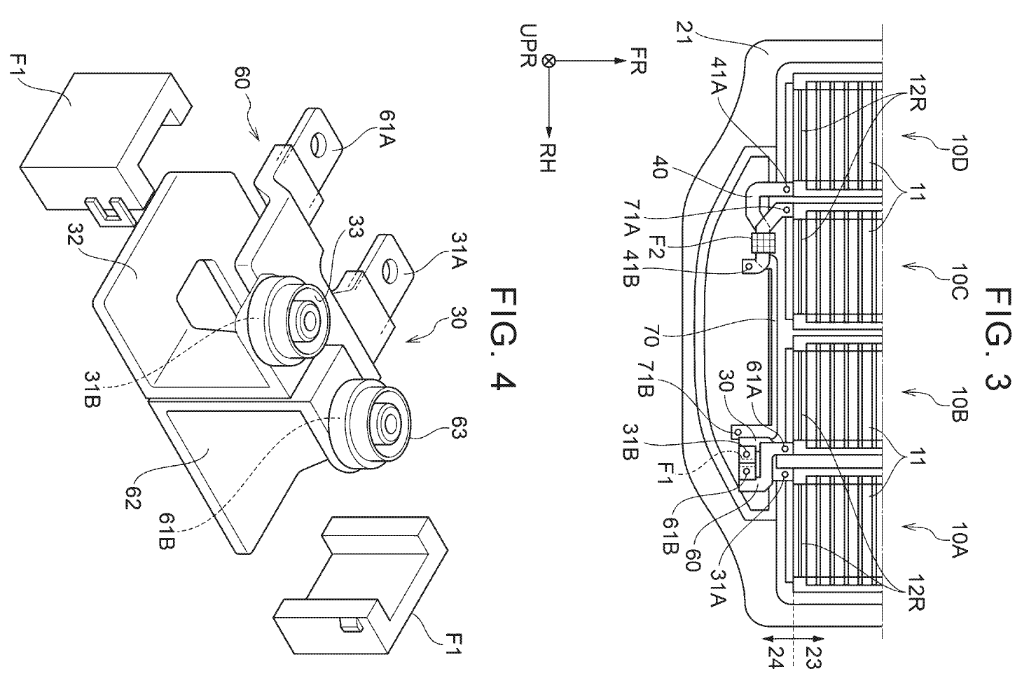

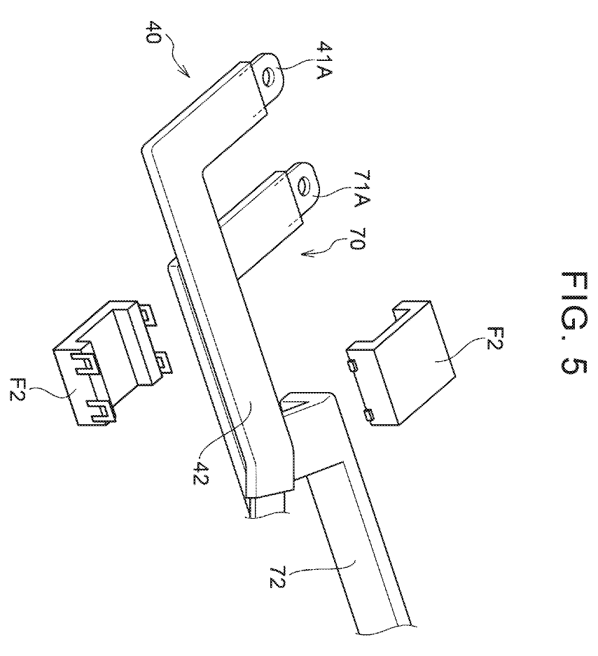

FIG. 3 is a schematic enlarged plan view of the busbar placement region of the energy storage device shown in FIG. 1. As shown in FIGS. 2 and 3, the positive busbar 30 is connected to the positive electrodes of the energy storage modules 10A to 10D and extends into the busbar placement region 24. The positive busbar 30 connects the energy storage modules 10A to 10D with the electrical device 50. In the present embodiment, contact portions 31A, 31B are respectively provided at both ends of the positive busbar 30 (see FIG. 4). One of the two contact portions, namely the contact portion 31A, may be electrically connected to the terminal 15R of the first energy storage module 10A located at one end in the left-right direction, specifically on the rightmost side among the energy storage modules 10A to 10D. Portions of the positive busbar 30 other than the contact portions 31A, 31B may be covered with an insulating cover 32 (see FIG. 4). Various busbars, including the positive busbar 30 used in the present embodiment, may be made of copper, aluminum, brass, or an alloy thereof.

As shown in FIGS. 2 and 3, the negative busbar 40 is connected to the negative electrodes of the energy storage modules 10A to 10D and extends into the busbar placement region 24. Like the positive busbar 30, the negative busbar 40 also connects the energy storage modules 10A to 10D with the electrical device 50. In the present embodiment, contact portions 41A, 41B are respectively provided at both ends of the negative busbar 40. One of the two contact portions, namely the contact portion 41A, may be electrically connected to the terminal 15R of the fourth energy storage module 10D among the energy storage modules 10A to 10D. Portions of the negative busbar 40 other than the contact portions 41A, 41B may be covered with an insulating cover 42 (see FIG. 5).

In the energy storage device 1, the first energy storage module 10A and the second energy storage module 10B may be electrically connected to each other by an inter-module busbar 80, and the third energy storage module 10C and the fourth energy storage module 10D may also be electrically connected to each other by an inter-module busbar 80.

As shown in FIGS. 2 and 3, the neutral-point busbars 60, 70, like the positive busbar 30 and the negative busbar 40, form wiring that connects the four energy storage modules 10A to 10D with the electrical device 50. Each of the neutral-point busbars 60, 70 may be formed of, for example, a strip-shaped metal plate. Contact portions 61A, 61B may be respectively provided at both ends of the neutral-point busbar 60, and contact portions 71A, 71B may be respectively provided at both ends of the neutral-point busbar 70. One of the two contact portions of the neutral-point busbar 60, namely the contact portion 61A, and one of the two contact portions of the neutral-point busbar 70, namely the contact portion 71A, are respectively connected to the electrodes that constitute the neutral point of the second and third energy storage modules 10B, 10C located in the middle in the left-right direction among the four electrically connected modules 10A to 10D. The neutral point of the energy storage device 1 of the present embodiment is a connection point between the second and third energy storage modules 10B, 10C. Accordingly, one of the two contact portions of one of the two neutral-point busbars, namely the contact portion 61A of the neutral-point busbar 60, is electrically connected to the terminal 15R provided on the rear end plate 12R of the second energy storage module 10B. One of the two contact portions of the other neutral-point busbar 70, namely the contact portion 71A, is electrically connected to the terminal 15R provided on the rear end plate 12R of the third energy storage module 10C. Portions of the neutral-point busbar 60 other than the contact portions 61A, 61B may be covered with an insulating cover 62 (see FIG. 4), and portions of the neutral-point busbar 70 other than the contact portions 71A, 71B may be covered with an insulating cover 72 (see FIG. 5). The term "neutral point" refers to an intermediate point having a potential halfway between the voltages of a plurality of electrically connected energy storage modules, or a point serving as a voltage reference point. The neutral point does not have to be a point having a potential exactly halfway between the voltages of the plurality of energy storage modules, as long as it has an intermediate potential between the voltages of the positive busbar 30 and the negative busbar 40.

As described above, in the present embodiment, the positive busbar 30, the negative busbar 40, and the neutral-point busbars 60, 70 are disposed in the busbar placement region 24. Therefore, the wiring space for each busbar is concentrated behind the energy storage modules 10A to 10D. This allows the energy storage modules 10A to 10D to be arranged in the module installation region 23 with high space efficiency. In addition, since the positive busbar 30, the negative busbar 40, and the neutral-point busbars 60, 70 are arranged together in one area, assembly work including connection between each busbar and the electrical device 50 etc. is facilitated.

FIG. 4 is an enlarged perspective view illustrating a main part of the positive busbar and one of the neutral-point busbars. FIG. 5 is an enlarged perspective view illustrating a main part of the negative busbar and the other neutral-point busbar. The connection structure between each busbar and the electrical device 50 will be described below with reference mainly to FIGS. 2 to 5.

As shown in FIGS. 2 and 4, the positive busbar 30 and the neutral-point busbar 60 extend rearward from the first and second energy storage modules 10A, 10B. As shown in FIGS. 2 and 5, the negative busbar 40 and the neutral-point busbar 70 extend rearward from the third and fourth energy storage modules 10C, 10D. In the present embodiment, the other contact portion 31B of the positive busbar 30 is connected to a terminal block 33. Similarly, the other contact portion 41B of the negative busbar 40 is connected to a terminal block 43, the other contact portion 61B of the neutral-point busbar 60 is connected to a terminal block 63, and the other contact portion 71B of the neutral-point busbar 70 is connected to a terminal block 73. The positive busbar 30, the negative busbar 40, and the neutral-point busbars 60, 70 are configured to be electrically connected to the electrical device 50 via the terminal blocks 33, 43, 63, 73, respectively. In FIG. 2, among the terminal blocks 33, 43, 63, 73, the terminal block 43 to which the other contact portion 41B of the negative busbar 40 is connected and the terminal block 73 to which the other contact portion 71B of the neutral-point busbar 70 is connected are arranged at positions hidden by other components.

As shown in FIGS. 3 to 5, the energy storage device 1 may include a device-side positive busbar 51, a device-side negative busbar 52, and two device-side neutral-point busbars 53, 54, each having one end connected to the terminal blocks 33, 43, 63, 73, respectively. The four device-side busbars 51 to 54 may be formed of strip-shaped metal plates arranged behind the electrical device 50. The other ends of the four device-side busbars 51 to 54 may be electrically connected to the electrical device 50, more specifically, to a junction box.

Noise may enter the positive busbar 30, the negative busbar 40, and the neutral-point busbars 60, 70 from devices, contact portions, etc. connected to the busbars. To remove such noise, it is preferable to attach noise filters to the respective busbars. In the present embodiment, noise filters are attached to portions of the positive busbar 30, the negative busbar 40, and the neutral-point busbars 60, 70 that extend into the busbar placement region 24. More specifically, as an example of noise filters, a first ferrite core F1 is attached so as to surround a portion of the positive busbar 30 and a portion of the neutral-point busbar 60, and a second ferrite core F2 is attached so as to surround a portion of the negative busbar 40 and a portion of the neutral-point busbar 70.

As shown in FIG. 4, the first ferrite core F1 may be attached around the intermediate portions, in the extending direction, of the positive busbar 30 and the neutral-point busbar 60 that are located adjacent to each other. FIG. 4 illustrates an example in which the first ferrite core F1 is a so-called snap-on ferrite core, which is a ring-shaped ferrite core divided along its axial direction into two parts that can be opened and closed.

In order to attach the first ferrite core F1, it is preferable that the shapes of the positive busbar 30 and the neutral-point busbar 60 be adjusted such that their intermediate portions are located adjacent to each other. In addition, it is preferable that the routing configuration of the positive busbar 30 and the neutral-point busbar 60 be designed such that the currents flow in opposite directions through the portions of the positive busbar 30 and the neutral-point busbar 60 to which the first ferrite core F1 is attached. When the currents flow in opposite directions through the portions of the respective busbars to which the first ferrite core F1 is attached, the first ferrite core F1 can effectively remove common-mode noise from the busbars.

As shown in FIG. 5, the second ferrite core F2 may be attached around the intermediate portions, in the longitudinal direction, of the negative busbar 40 and the neutral-point busbar 70 that are located adjacent to each other. FIG. 5 illustrates an example in which, like the first ferrite core F1 described above, a so-called snap-on ferrite core is employed as the second ferrite core F2.

In order to attach the second ferrite core F2, it is preferable that the shapes of the negative busbar 40 and the neutral-point busbar 70 be adjusted such that their intermediate portions are located adjacent to each other. In addition, it is preferable that the routing configuration of the negative busbar 40 and the neutral-point busbar 70 be designed such that the currents flow in opposite directions through the portions of the negative busbar 40 and the neutral-point busbar 70 to which the second ferrite core F2 is attached, because common-mode noise can be effectively removed from the busbars.

The above example illustrates a case where the first and second ferrite cores F1, F2 are employed as noise filters. However, one noise filter may be attached to a portion of each of the positive busbar 30, the negative busbar 40, and the neutral-point busbars 60, 70. The type of noise filter is not limited to ferrite cores, and other types of noise filters such as common-mode chokes, inductor-capacitor (LC) filters, or electromagnetic interference (EMI) filters may also be employed.

As in the present embodiment, when the positive busbar 30, the negative busbar 40, and the neutral-point busbars 60, 70 extend rearward from the four energy storage modules 10A to 10D, attaching the first and second ferrite cores F1, F2 to those portions does not affect the installation space for the energy storage modules 10A to 10D. Accordingly, it is possible to remove noise mixed into the busbars while keeping the installation space for the energy storage modules 10A to 10D compact. Furthermore, since the positive busbar 30, the negative busbar 40, and the neutral-point busbars 60, 70 are all disposed within the busbar placement region 24, installation of noise filters that cover these busbars is facilitated.

The attachment positions of the first and second ferrite cores F1, F2 can be changed as desired as long as they are located at intermediate portions of any of the busbars. Although snap-on ferrite cores are illustrated as the first and second ferrite cores F1, F2 in FIGS. 4 and 5, the shapes of the ferrite cores are not particularly limited, and plate-shaped or ring-shaped ferrite cores or other types of ferrite cores may also be used.

As described above, in the energy storage device 1 of the present embodiment, noise filters are attached to the positive busbar 30, the negative busbar 40, and the neutral-point busbars 60, 70 that extend rearward from the energy storage modules 10A to 10D. This makes it possible to remove noise entering the busbars with a simple configuration. In particular, in the energy storage device 1 of the present embodiment, the busbars are configured to extend into the same area. Therefore, the installation work of the noise filters is facilitated. Furthermore, since a single noise filter can be attached to multiple busbars, the total number of components can be reduced.

The present disclosure is not limited to the embodiment described above, and various modifications may be made without departing from the spirit and scope of the disclosure. All such modifications are included in the technical concept of the present disclosure. Unless otherwise specified in the specification, each component of the present disclosure is not limited to a single one, and two or more may be provided.

What is claimed is:

1. An energy storage device comprising:
a plurality of energy storage modules each including a plurality of energy storage cells arranged along a first direction, the energy storage modules being arranged along a second direction intersecting the first direction and electrically connected to each other;
a positive busbar that is connected to a positive electrode of the energy storage module located at a first end in the second direction among the energy storage modules, and extends on one side of the energy storage modules in the first direction;
a negative busbar that is connected to a negative electrode of the energy storage module located at a second end in the second direction among the energy storage modules, and extends on the one side of the energy storage modules;
a pair of neutral-point busbars that is respectively connected to a positive electrode and a negative electrode of the energy storage module located at an intermediate position in the second direction among the energy storage modules, and extends on the one side of the energy storage modules; and
a noise filter attached so as to surround at least part of a portion, extending on the one side of the energy storage modules, of at least one of the positive busbar, the negative busbar, and the neutral-point busbars.

2. The energy storage device according to claim 1, wherein the noise filter includes a first noise filter attached so as to surround a part of the positive busbar and a part of one of the neutral-point busbars, and a second noise filter attached so as to surround a part of the negative busbar and a part of the other neutral-point busbar.

3. The energy storage device according to claim 2, wherein a direction of current flowing through the part of the positive busbar and the part of the one neutral-point busbar to which the first noise filter is attached, and a direction of current flowing through the part of the negative busbar and the part of the other neutral-point busbar to which the second noise filter is attached, are opposite to each other.

4. The energy storage device according to claim 1, further comprising an electrical device connected to the energy storage modules and positioned so as to at least partially overlap the positive busbar, the negative busbar, and the neutral-point busbars in a third direction intersecting both the first direction and the second direction,
wherein the positive busbar, the negative busbar, and the neutral-point busbars are electrically connected to the electrical device.

5. The energy storage device according to claim 1, further comprising a housing in which the energy storage modules arranged in parallel along the second direction are installed, the housing including a module installation region in which the energy storage modules are installed, and a busbar placement region that is provided on the one side of the module installation region and in which the positive busbar, the negative busbar, and the neutral-point busbars are disposed.
